(19) United States
(12) Patent Application Publication
(10) Pub. No.: US 2008/0298617 A1
(43) Pub. Date: Dec. 4, 2008

(54) Hearing aid component holder with battery cavity

(75) Inventor: Thomas Kasztelan, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/156,112

(22) Filed: May 29, 2008

(30) Foreign Application Priority Data
May 30, 2007 (DE) 10 2007 025 080.2

(51) Int. Cl. H04R 25/00

(52) U.S. Cl. 381/323

(57) ABSTRACT

A hearing aid component holder is provided with a cavity comprising a base. A battery may be inserted into the cavity so that the battery is fixed laterally in the main extension plane of the hearing aid component holder through the walls of the cavity and in the insertion direction through the base. A battery contact is arranged in the cavity on the base.

### CROSS REFERENCE TO RELATED APPLICATIONS

This application claims priority of German application No. 10 2007 025 080.2 DE filed May 30, 2007, which is incorporated by reference herein in its entirety.

### FIELD OF INVENTION

The present invention relates to a hearing aid component holder on which electronic components of a hearing aid are secured and contacted.

### BACKGROUND OF INVENTION

Hearing aids are portable hearing devices provided to people with impaired hearing. In order to accommodate the numerous individual requirements, different designs of hearing aids are provided, such as behind-the-ear-hearing aids (BTEs) and in-the-ear-hearing aids (ITEs), for example also concha-hearing aids or completely-in-the-canal hearing aids (CICs). The hearing aids described by way of example are worn on the outer ear or in the auditory canal. In addition, also available on the market are bone conduction hearing aids, implantable or vibrotactile hearing aids. In such cases, the damaged hearing is stimulated either mechanically or electrically.

In principle, hearing aids have the following essential components: an input transducer, an amplifier and an output transducer. The input transducer is generally a sound pickup, for example a microphone, and/or an electromagnetic receiver, for example an induction coil. The output transducer is generally implemented as an electroacoustic transducer, for example a miniature loudspeaker, or as an electromechanical transducer, for example a bone conduction hearing aid. The amplifier is usually integrated in a signal processing unit. This basic structure is shown in FIG. 1 using the example of a behind-the-ear hearing aid. One or more microphones 2 to pick up the sound from the environment are integrated in a hearing aid housing 1 for wearing behind the ear. A signal processing unit 3, which is also integrated in the hearing aid housing 1 processes and amplifies the microphone signals. The output signal from the signal processing unit 3 is transmitted to a loud speaker or receiver 4, which issues an acoustic signal. The sound may optionally be transmitted via an acoustic tube, which is fixed in the auditory canal with an otoplastic, to the eardrum of the person wearing the device. The power supply for the hearing aid and in particular for the signal processing unit 3 is provided by a battery 5 which is also integrated in the hearing aid housing 1.

Usually, the battery of a hearing aid is held in a separate battery compartment and contacted there. In the case of ITE hearing aids, as a rule, the battery compartment is located on the so-called “faceplate”. Thus, the battery compartment cover, which comprises an opening lever, does not lie on the auditory canal. The other electronic components of the hearing aid then have to be suitably arranged around the battery compartment. This applies in particular to the microphones, the hearing device and the amplifier plate. These requirements mean the aim of achieving the smallest possible design can only be achieved to a certain degree.

Known from publication EP 0 684 749 A2 is an in-the-ear hearing aid, into the cover of which a battery can be inserted. For this, the cover comprises a suitable cavity and a battery contact is provided on the base of the cavity.

In addition, publication U.S. Pat. No. 7,201,996 B1 describes a sound generator for a portable device. A loudspeaker and a battery are held jointly by a case.

Finally, publication EP 0 971 410 A2 discloses a module comprising an integrated circuit and a button battery. A polyimide layer is applied to the battery which serves as a carrier for the integrated circuit.

### SUMMARY OF INVENTION

Therefore, it is the object of the present invention further to reduce the size of the design of a hearing aid. According to the invention, this object is achieved by a hearing aid component holder, which is designed as a printed circuit board comprising a cavity having a base and into which a battery may be inserted so that the battery is fixed laterally in the main extension plane of the hearing aid component holder through the walls of the cavity and in the insertion direction through the base, and a battery contact, which is arranged in the cavity on the base.

In an advantageous way, therefore, it is possible to dispense with a special battery compartment or a separate holder for the battery. In addition, better use can be made of the volume of the hearing aid component holder which is still present.

Preferably, the hearing aid component holder according to the invention comprises at least two layers of which one comprises a round borehole and another forms the base with the battery contact. This multilayer formation means the battery receptacle is easy to make. Namely, all that is required is to provide a borehole in one layer and a battery contact in the layer lying therebelow.

It is further advantageous if the hearing aid component holder is designed as a ceramic multilayer printed circuit board. In particular, the carrier can be produced using LTCC® (low temperature cofired ceramic) technology wherein the ceramic carrier material is shaped as desired in unfired condition.

Alternatively, the hearing aid component holder can be formed as a thick film laminate or glass fiber resin laminate. For this, the technology used for chip manufacturing or printed circuit board manufacturing is used.

The hearing aid component holder can further carry a hearing aid amplifier which is in electrical contact with the battery contact. This enables the achievement of a low-impedance connection of the battery to the amplifier.

According to another development of the hearing aid component holder, a contact spring is soldered onto its surface forming a second electrical contact to the battery to be inserted into the cavity. This contact spring can simultaneously serve as the cover of the cavity so that the battery is held in the cavity without further mechanical aids.

As is already evident from the preceding passages, the hearing aid component holder described is preferably inserted in a hearing aid comprising a battery, which is inserted into the cavity, and a battery compartment cover which comprises a further battery contact and contacts the side of the battery facing away from the base in a closed condition. This means that conventional contact technologies can be used for the contacting of the battery.

### BRIEF DESCRIPTION OF THE DRAWINGS

The present invention will now be explained in more detail with reference to the attached drawings, which show:

FIG. 1 the basic design of a hearing aid with its essential electronic components and

FIG. 2 a hearing aid component holder according to the invention with a battery cavity.

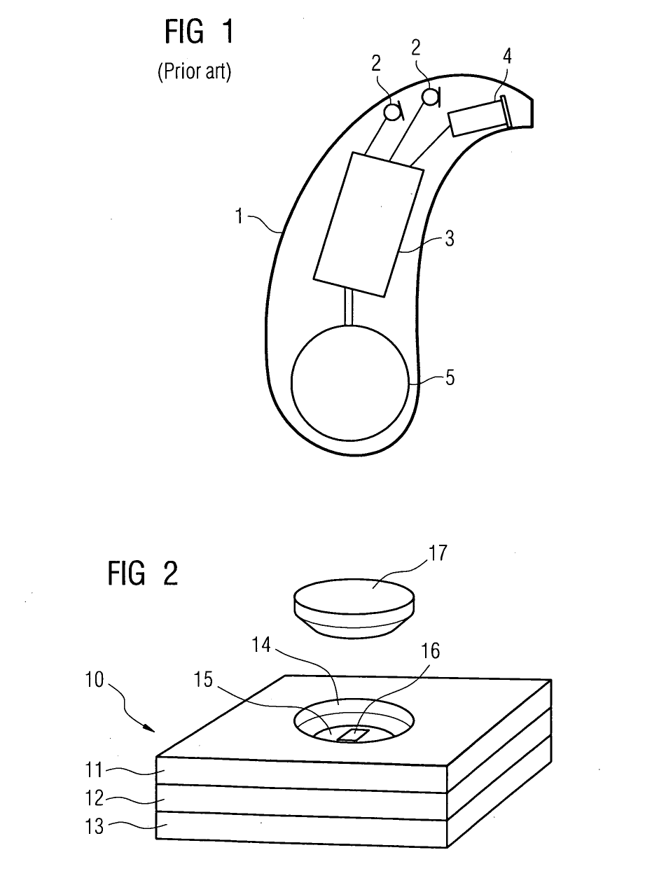

### DETAILED DESCRIPTION OF INVENTION

The exemplary embodiment described below in more detail represents a preferred embodiment of the present invention.

FIG. 2 shows a part of an example of a hearing aid component holder 10. Here, this is constructed in LTCC® technology and comprises three layers: a first layer 11, a second layer 12 and a third layer 13. The number of layers is in principle optional, but is at least two.

The first layer 11, in FIG. 2 the uppermost layer, is provided with a cavity or recess 14. This cavity 14 extends through the complete first layer so that a segment 15 of the second layer 12 is exposed. A battery contact 16 is placed in this section 15. The battery contact 16 is connected to a suitable conductor in or on the second layer 12.

Located in or on the component carrier 10 are electrically contacted electronic components of a hearing aid. These are not shown in FIG. 2. Components of this kind are in particular an amplifier chip, a computer, a memory, driver and the like, if necessary. The circuit of these components is provided by the component carrier 10 embodied as a multilayer printed circuit board (multilayer board). Alternatively, the LTCC® carrier can also be constructed using thick film or glass fiber resin laminate technology.

A battery 17 is inserted into cavity 14. In the example of FIG. 2, this has the typical shape of a button cell. The cavity 14 comprises a corresponding negative contour so that, in an inserted condition, the battery is fixed laterally, i.e. perpendicularly to the insertion direction or in the main extension plane of the carrier 10. In the insertion direction, the battery 17 is held by the second layer 12 or the battery contact 16 located thereupon. Holding in the insertion direction can also be ensured by the cavity 14 having a conical contour such as that of the lower part of the battery 17. This enables pressure to be applied to the battery contact 16 in the desired way. A contour of this kind can be achieved, for example, by a laser or mechanically in the “green”(=unfired) film. After shaping, the flexible ceramic films are then printed for example with a proven thick-film technique so that the desired conductors are achieved on the surface or between the layers of the carrier 10. The printed ceramic films are then laminated and sintered at, for example, 900° C. to produce a 3-dimensionally crosslinked multilayer carrier made of ceramic, which can be used as an reinforcing substrate. In FIG. 2, the conductors are not shown for purposes of clarity.

The above described hearing aid component holder 10 shows a low-impedance or low-inductance connection of the battery 17 to an amplifier (not shown). Since, in addition, no special battery holder is required, in an advantageous way space saving is achieved. The battery 17 can, for example, be fixed and contacted by a device for closing the battery compartment or by a spring soldered onto the surface of the carrier.

A further advantage of the carrier design according to the invention with a battery cavity consists in the fact that only a small magnetic interference field is emitted from the short battery contacts. This is particularly advantageous with telephone coil applications.

1.-7. (canceled)

8. A hearing aid component holder, comprising:
a cavity having a base, the cavity for insertion of a battery such that the battery is fixed laterally in a main extension plane of the hearing aid component holder through the walls of the cavity and in the insertion direction through the base; and
a battery contact arranged in the cavity on the base.

9. The hearing aid component holder as claimed in claim 8, further comprising at least two layers of which one comprises a round borehole as a cavity and another forms the base with the battery contact.

10. The hearing aid component holder as claimed in claim 9, wherein the component holder is a ceramic multilayer printed circuit board.

11. The hearing aid component holder as claimed in claim 9, wherein the component holder is formed as a thick film laminate or glass fiber resin laminate.

12. The hearing aid component holder as claimed in claim 8, further comprises a hearing aid amplifier having electric contact with the battery contact.

13. The hearing aid component holder as claimed in claim 8, further comprises a contact spring soldered onto the surface of component holder and which forms a second electrical contact to the battery when inserted into the cavity.

14. A hearing aid component holder, comprising:
a first layer and a second layer,
the first layer comprises a cavity for the insertion a battery,
at least a portion of the second layer forms a base of the cavity, the second layer comprises a battery contact at the base; and
a hearing aid amplifier having electric contact with the battery contact.

15. A hearing aid with a hearing aid, comprising:
a battery;
a ceramic multilayer printed circuit board having a first layer and a second layer,
the first layer comprises a cavity for the insertion the battery,
at least a portion of the second layer forms a base of the cavity, the second layer comprises a battery contact at the base;
a battery contact arranged in the cavity on the base; and
a battery compartment cover comprising a further battery contact and which contacts the side of the battery facing away from the base when the cover is in a closed condition.

16. The hearing aid as claimed in claim 14, wherein the circuit board is formed as a thick film laminate or glass fiber resin laminate.

17. The hearing aid as claimed in claim 14, wherein the circuit board comprises a hearing aid amplifier which is in electric contact with the battery contact.
